(19) United States
(12) Patent Application Publication
(10) Pub. No.: US 2018/0109851 A1
(43) Pub. Date: Apr. 19, 2018

(54) CONTENT PLAYBACK MANAGEMENT

(71) Applicant: BRITISH TELECOMMUNICATIONS PUBLIC LIMITED COMPANY, London (GB)

(72) Inventor: Scott FINLAYSON, London (GB)

(21) Appl. No.: 15/562,596

(22) PCT Filed: Mar. 24, 2016
(86) PCT No.: PCT/EP2016/056663

§ 371 Date: Sep. 28, 2017

(30) Foreign Application Priority Data
Mar. 31, 2015 (EP) 15162113.3

(51) Int. Cl. H04N 21/654; H04N 21/442; H04N 21/426

(52) U.S. Cl. CPC H04N 21/654; H04L 67/42; H04N 21/42684; H04N 21/44236

(57) ABSTRACT

A server and method for terminating, at a target client device, playback of content provided from a server to the target client device. A target client device at which playback is to be terminated is identified. On receiving at the service provider network from a requesting client device, a request comprising an identifier related to the requesting client device; the identifier related to the requesting client device is read and a store is checked for an identifier related to the target client device that matches the identifier related to the requesting client device. Where the store comprises at least one identifier related to the target client device that matches the identifier related to the requesting client device; a message including an indication that playback of content should terminate on the requesting client device is sent to the requesting client device in a response to the request.

### TECHNICAL FIELD

The invention is concerned with the management of content playback. The invention is particularly concerned with terminating playback of content at a client device.

### BACKGROUND TO THE INVENTION AND PRIOR ART

Providers of content, for example video content, TV programmes, films, etc., for playback on a user device respond to requests for content from a user by providing from a server located in a service provider network to the user (i.e. to a client device operated by a customer of the content provider organisation), content either as a complete download for playback at a later time or as a stream for simultaneous playback. However, some customers may contravene their agreement with the content provider organisation by sharing with other users, content that they have obtained from a content provider for their personal use. Such behaviour may result in large numbers of users obtaining access to content to which they are not entitled. Such customer behaviour deprives the content provider of income to which they are entitled and can affect the profitability and the viability of the content provider business.

### STATEMENT OF INVENTION

There is provided a method of terminating, at a target client device, playback of content provided from a server to the target client device, in which the method comprises:

identifying a target client device at which playback is to be terminated;

receiving at the service provider network from a requesting client device, a request; in which the request comprises an identifier related to the requesting client device;

reading from the request, the identifier related to the requesting client device and checking a store for an identifier related to the target client device that matches the identifier related to the requesting client device; and

where the store comprises at least one identifier related to the target client device that matches the identifier related to the requesting client device; including in a message sent to the requesting client device in a response to the request, an indication that playback of content should terminate on the requesting client device.

The method provides a mechanism for identifying and communicating with a client device (for example, a device deemed to be operating contrary to the terms and conditions of agreement between a customer and a service provider organisation) where the service provider organisation provides content for playback for the customer via the client device.

According to an aspect of the invention, the request is directed from the requesting client device to a server in the service provider network; in which the request is routed via an intermediate node (e.g. a traffic manager) located between the requesting client device and the server; in which the method comprises:

at the intermediate node:
reading in the request the identifier related to the requesting client device;
checking the store for an identifier related to the target client device that matches the identifier related to the requesting client device; and

where an identifier related to the target client device that matches the identifier related to the requesting client device is identified in the store,

at the intermediate node:
generating the message sent to the requesting client device in a response to the request.

According to the above aspect, an intermediate node, such as traffic manager, can be configured to intercept a request from a client device (i.e. a client device whose identifier matches the target client device identifier) so as to determine if the request originated with a target client device. The intermediate node can be configured to generate a response to the intercepted request to cause the (target) client device to terminate playback.

According to a second aspect of the invention, the request is directed from the requesting client device to a server in the service provider network; in which the request is routed via an intermediate node (e.g. a traffic manager) located between the requesting client device and the server; in which the method comprises:

at the intermediate node:
reading in the request the identifier related to the requesting client device;
checking the store for an identifier related to the target client device that matches the identifier related to the requesting client device; and
where an identifier related to the target client device that matches the identifier related to the requesting client device is identified in the store;

at the intermediate node:
receiving from the server, a message directed to the requesting client device in a response to the request;
modifying the message directed to the requesting client device by inserting an indication that playback of content should terminate on the requesting client device; and
sending the modified message to the requesting client device.

According to the above, second aspect, an intermediate node, such as traffic manager, can be configured to intercept a request from a client device (i.e. a client device whose identifier matches the target client device identifier) so as to determine if the request originated with a target client device. The intermediate node can be configured to intercept a response generated elsewhere to the intercepted request. The intercepted request can be modified by the intermediate node to cause the (target) client device to terminate playback.

According to a third aspect of the invention, the request is directed from the requesting client device to a server in the service provider network; in which the request is routed via an intermediate node located between the requesting client device and the server; in which the method comprises:

at the intermediate node:
reading in the request the identifier related to the requesting client device;
checking the store for an identifier related to the target client device that matches the identifier related to the requesting client device; and

where an identifier related to the target client device that matches the identifier related to the requesting client device is identified in the store,

at the intermediate node:
modifying the request by insertion of data for inclusion in the message sent to the requesting client device in a response to the request;
in which the data comprises an indication that playback of content should terminate on the requesting client device.

According to a further aspect of the invention, each identifier comprises one of a client device identifier, a session identifier, a customer identifier and a household identifier. According to a further aspect of the invention, each identifier comprises one of a client device identifier, a session identifier for a session between a server and a client device, a customer identifier for a registered user of a client device and a household identifier registered for at least one client device.

There is also provided a server comprising a processor configured in use to:

receive from a requesting client device, a request directed to a service provider network;

read from the request an identifier related to the requesting client device;

check a store for an identifier related to a target client device that matches the identifier related to the requesting client device; and

where the store comprises at least one identifier related to a target client device that matches the identifier related to the requesting client device; include in a message sent to the requesting client device in a response to the request, an indication that playback of content should terminate on the requesting client device.

### BRIEF DESCRIPTION OF THE DRAWINGS

FIG. 1 shows a schematic representation of a network according to aspects of the present invention;

FIGS. 2a, 2b and 2c show signal flows in the network of FIG. 1 according to aspects of the present invention;

FIGS. 3a, 3b, 4 and 5 show flow charts representing operation of aspects of the invention;

FIG. 6 shows a block diagram of a computer system suitable for the operation of aspects of the present invention.

### DETAILED DESCRIPTION OF EMBODIMENTS OF THE INVENTION

A server and method for terminating, at a target client device, playback of content provided from a server to the target client device. A target client device at which playback is to be terminated is identified. On receiving at the service provider network from a requesting client device, a request comprising an identifier related to the requesting client device; the identifier related to the requesting client device is read and a store is checked for an identifier related to the target client device that matches the identifier related to the requesting client device. Where the store comprises at least one identifier related to the target client device that matches the identifier related to the requesting client device; a message is sent to the requesting client device in a response to the request, in which the message includes an indication that playback of content should terminate on the requesting client device.

According to embodiments of the invention, a mechanism is provided for termination of content playback on a client device. Requests from the client device are monitored and used to provide a mechanism for notifying a client device about content whose playback is to be terminated. A termination database stores entries that indicate one or more target client devices on which playback is to be terminated. The requests are checked against these entries to identify requests found to relate to a target device. Messages to target client devices indicating that content playback is to be terminated are included in responses to the identified requests. The termination database entries may include details of sessions, client devices, customers and households and are sourced from a termination utility (in the following, the terms “customer” and “user” are used interchangeably as a customer will effectively use a content provider service and a many users will be some kind of customer, in that they will have some form of relationship with the content provider organisation that permits access to content). The service provider network is configured to compare requests received from a client device with entries in the session termination database. Where a match is found (i.e. a request is found to relate to a customer, a client device, a session or a household that has a matching entry in the session termination database) the service provider network is configured to generate a response to the request that includes an indication to the client device to terminate playback.

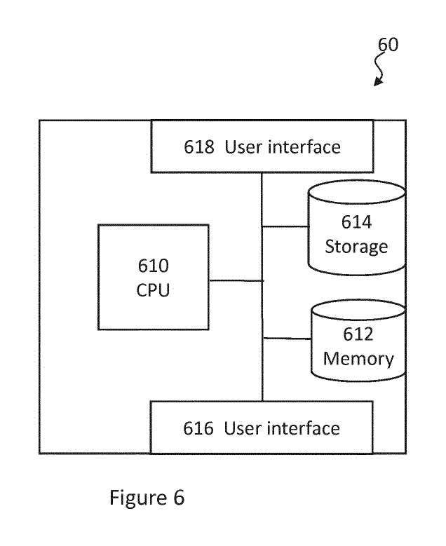

According to an embodiment, an operations team, responsible for managing operation of the content delivery network, may provide details to the termination utility of content to be terminated. The termination utility may comprise a computer system (e.g. such as that shown in FIG. 6) which provides the operations team with a user interface as well feeding information to the session termination database. According to an embodiment, members of the operations team are able to obtain information on sharing, with other users, of content obtained from a content provider for personal use by one customer or by one household. For example, the operations team may be alerted to a rogue web site making available to the general public content originally provided by the content provider to customers, where the content originally provided was restricted to personal use only. The operations team may cause each client device receiving the same content as that made available via the rogue web site (but not restricted to client devices receiving content through the rogue web site) to inject a device identifier into the content as it is played back. Subsequent detection of a device identifier in the content being shared via the rogue website will enable the operations team to identify the client device from which the shared content is derived.

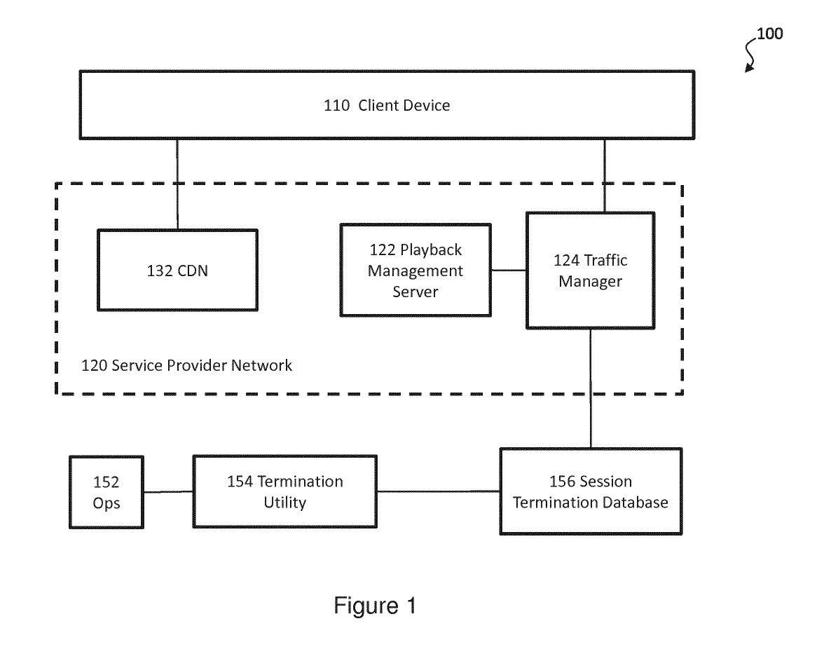

FIG. 1 shows network 100, in which client device 110 is connected to service provider network 120. Service provider network 120 comprises content distribution network (CDN) 132 (e.g. a computer system or a plurality of linked computer systems such as that shown in FIG. 6) for the provision of content to client device 110 and playback management server 122 (e.g. a computer system or a plurality of linked computer systems such as that shown in FIG. 6) and traffic manger 124 (for example a Stingray traffic manager available from Riverbed Technology, San Francisco, Calif., USA), for managing content handling. Client device 110 sources content from CDN 132 for display to a user operating client device 110. Content may be displayed on client device 110 (e.g. where client device 110 is a device incorporating a suitable display, such as a networked personal computer) or on a separate display device such as a computer display or a television—either directly or via a Chromecast interface—(e.g. where client device 110 is a set-top box or similar). CDN 132 comprises one or more stores for holding content for supply, either by streaming or download, to the client device 110. Playback management server 132 is arranged in communication with client device 110 via traffic manager 134. According to the invention, network 100 also includes termination utility 154 and session termination database 156. Session termination database 156 is arranged in communication with service provider network 120. According to an embodiments, termination utility 154 operates under control of an operations team 152. Operations team 152 monitors the operation of network 100 and provides inputs to termination utility 154 to store in session termination database 156 indications relating to content to be terminated, i.e. in cases where the playback is deemed invalid or unauthorised.

As described, above, the operations team identifies a device, session, customer or household identifier associated with content playback that is to be terminated, the operations team can instigate, via the termination utility user interface, the termination utility to send (240) the device, session, customer or household identifier to the session termination database 156, which maintains information relating to client devices where playback is to be terminated.

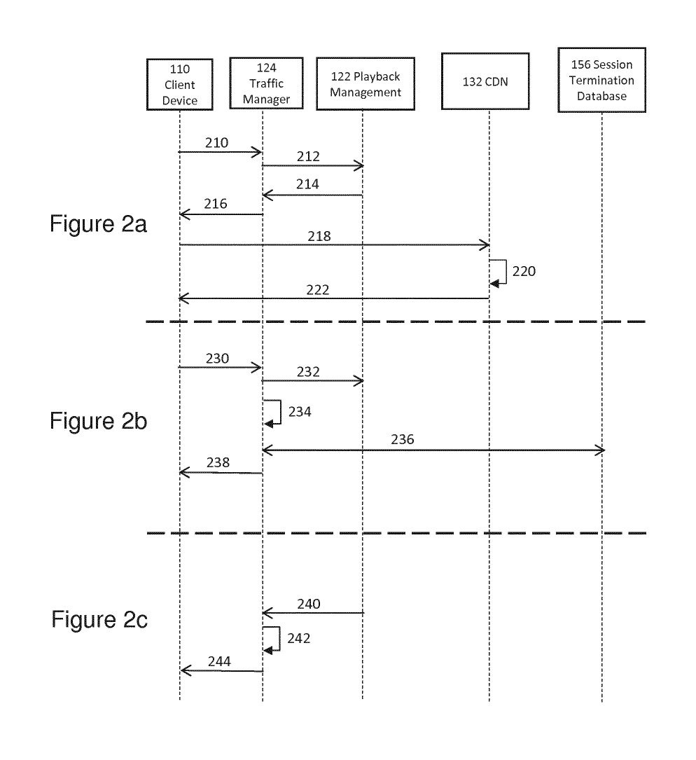

Operation of the invention will now be described by way of example with reference to the embodiments illustrated in FIGS. 2a, 2b and 2c.

Fetch Content

In normal operation, client device 110 will interact with service provider network 120, including by sending requests to the service provider network. For example, the client device will make requests, from time to time, in order to find out what content is available for playing, to check the user's account status and billing information and to request provision of new content. Advantageously, the invention exploits such requests to the service provider network 120 generated by the client device 110 in order to control the playback of content on a client device.

As shown in FIG. 2a, client device 110 sends to service provider network 120, a request 210 for content including details of the customer's account with the content provider. The request is received by traffic manger 124, which passes the request to playback management server 122. Playback management server 122 checks that the request is valid. If the request for content is found to be valid, the playback management server 122 provides 214, 216 to the client device 110, via the traffic manger 124, a session identifier for a new “provision-of-content” session for providing the requested content to the client device 110, the location of a CDN (e.g. CDN 132) where the requested content is stored, together with any access codes necessary to access the requested content (i.e. content information). The client device 110 uses the content information to compose a request for content 218 and direct the request to the indicated location of CDN 132. On receipt of the request, CDN 132 uses the content information provided in the request to locate 220 the requested content and provides 222 the content to the client device 110.

We now describe operation of the service provider network 120 in terminating playback following writing to the session termination database 156 an identifier related to a target client device on which playback is to be terminated. According to some embodiments of the invention, the service provider network 120 receives requests from a plurality of client devices and checks each request against details held by the session termination database. According to an embodiment, these requests pass via an intermediate node in the service provider network, for example the traffic manager 124. As shown in FIG. 2b, client device 110 sends a request 230, 232 to playback manger server 122 routed via traffic manager 124. On receipt of such a request from the client device 110 (which may be unrelated to content currently being played), the traffic manger 124 (i) passes 232 the request to its destination (e.g. playback manger server 122) but the traffic manger 124 also (ii) examines 234 details included in the request, including the identity of a device, session, customer or household. The traffic manger 124 checks 236 for a corresponding entry in the session termination database 156. For example, if the request includes a household identifier, the session termination database is checked for that household identifier. If, on the other hand, the request includes a customer identifier the session termination database is checked for that customer identifier, etc.

The session termination database may contain any of the following types of identifiers; session identifier, client device identifier, customer identifier and household identifier. Each type of identifier supports a different scope of termination of content playback on a client device. Examples of different scopes are shown Table 1:

TABLE 1

| Type of Identifier | Content Terminated |
|---|---|
| Session identifier for a session | Content delivered as part of the |
| between a server and a client | identified session |
| device | |
| Client device identifier | Content on that device |
| Customer identifier for a | Content on all devices registered with |
| registered user of a client | that customer |
| device | |
| Household identifier registered for | Content on all devices registered with |
| at least one client device | that household |

When the traffic manager 124 identifies a request that includes an identity corresponding to details held by the session termination database 156, the traffic manager may act according to different, alternative embodiments of the invention. According to a first alternative embodiment (shown in FIG. 2b), traffic manager 124 generates and sends 238 to the requesting client device 110, a response to the request received from requesting client device 110, in which the response contains an indication (for example a command or error code) to cause client device 110 to stop playing content. According to various further embodiments, the indication to client device 110 to stop playing content may cause a specific piece of content to be terminated; may cause all content being played on the requesting device to be terminated or may cause content being played on any client device associated with a customer or a household to be terminated.

The second alternative embodiment will now be described with reference to FIG. 2c. The second alternative embodiment also involves flows 230 to 236, already described above with reference to FIG. 2b but these are not shown in FIG. 2c and will not be described further here for reasons of efficiency. According to the second alternative embodiment, the response is generated elsewhere in the service provider network 120 (e.g. at playback manager server 122). For example, playback manager server 122 may send 240 the response to client device 110 via traffic manger 124. Traffic manger 124 receives the response and modifies the response 242 prior to sending 244 the modified response to client device 110. The response is modified at traffic manger 124 to add the indication to cause client device 110 to stop playing content at the traffic manager 124. As before, the indication to client device 110 to stop playing content may cause a specific piece of content to be terminated; may cause all content being played on the requesting device to be terminated or may cause content being played on any client device associated with a customer or a household to be terminated.

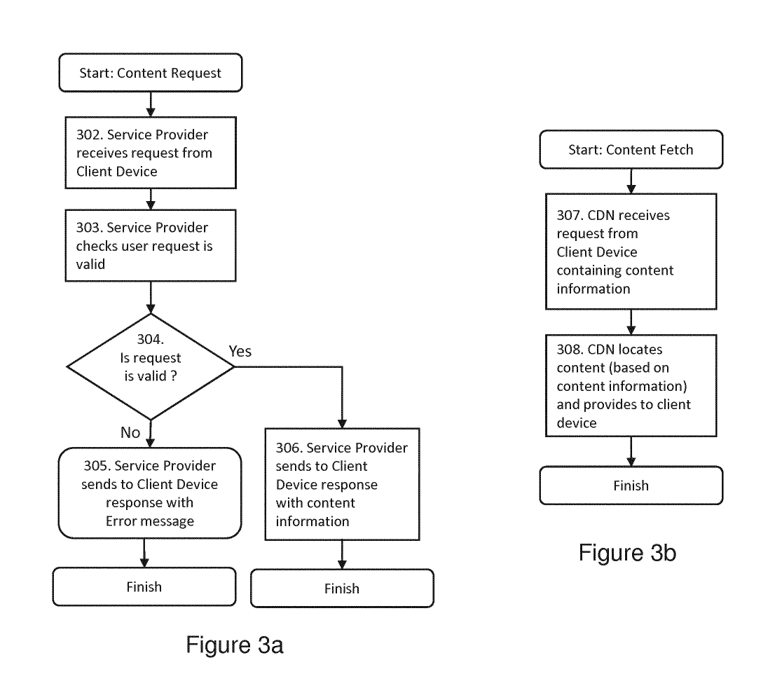

Operation of the service provider network 120 of the invention will now be described, by way of example, with reference to the embodiments illustrated in the flow charts of FIGS. 3a, 3b, 4 and 5.

As indicated, above, in normal operation, client device 110 will make requests 301, from time to time, in order to request provision of new content. As shown in FIG. 3a, service provider network 120 (e.g. playback management server 122) receives 302 a request for content from client device 110. Playback management server 122 checks 303 that the request is valid, e.g. that the account and device associated with the request are authorized to access the content indicated in the request and that granting of the request will not exceed the customer's quota defining the maximum number of content playing at one time. If the request for content is invalid (304 “No”), the playback management server 122 sends 305 to the client device 110, a response with an error message. If the request for content is valid (304 “Yes”), the playback management server 122 sends to the client device 110, content information for the requested content.

The client device 110 may use the content information to compose and direct a request for content to the indicated CDN location, so as to obtain the requested content. As shown in FIG. 3b, CDN 132 receives 307 a request from Client Device containing content information. Based on content information, CDN locates 308 the requested content and provides the content to the client device 110.

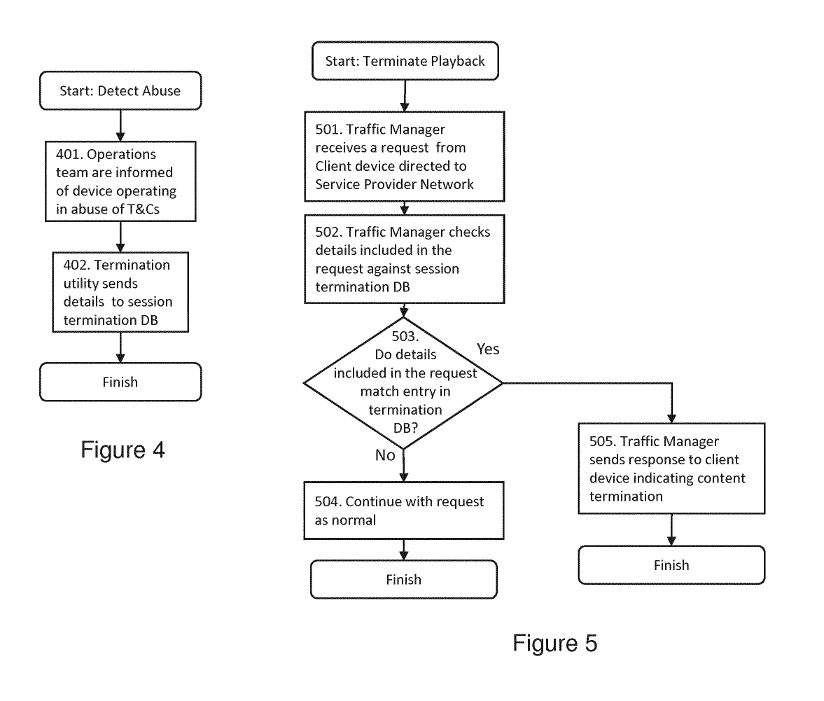

As indicated, above, the operations team 152 monitors the operation of network 100 and provides inputs to termination utility 154 to store in session termination database 156 indications relating to termination of playback, i.e. in cases where the playback is deemed invalid or unauthorised. As shown in FIG. 4, the operations team identify or are informed of 401 a “rogue” device (i.e. a device operating in abuse of an agreement between a customer and the service provider). According to an embodiment, an operations team, responsible for managing operation of the content delivery network, may provide details to the termination utility of, or relating to, client devices for termination of playback. The termination utility may comprise a component which provides the operations team with a user interface as well as feeding information to the session termination database. According to an embodiment, members of the operations team are able to obtain information on sharing, with other users, of content obtained from a content provider for personal use by one customer or by one household. For example, the operations team may be alerted to a rogue web site making available to the general public content originally provided by the content provider to customers, where the content originally provided was restricted to personal use only. The operations team may cause each client device receiving the same content as that made available via the rogue web site (but not restricted to client devices receiving content through the rogue web site) to inject a device identifier into the content as it is played back. Subsequent detection of a device identifier in the content being shared via the rogue website will enable the operations team to identify the client device from which the shared content is derived. Returning to FIG. 4, termination utility sends 402 details of the rogue client device to session termination database 156.

We now describe operation of the service provider network 120 in terminating playback with reference to FIG. 5. This activity is triggered by a client device 110 (referred to as the “requesting” client device and not necessarily the rogue client device) sending a request to service provider network 120 via traffic manger 124. According to embodiments of the invention, the service provider network 120 receives requests from a plurality of client devices and checks each request against details held by the session termination database. According to an embodiment, these requests pass via the traffic manager 124. Referring to FIG. 5, on receipt 501 of such a request (which may be unrelated to content currently being played) from the requesting client device, the traffic manger 124 examines 502 details included in the request, including the identity of a device, session, customer or household and checks 503 for a corresponding entry in the session termination database 156.

When the traffic manager identifies a request that does not includes an identity corresponding to details held by the session termination database (503 “No”), the traffic manager will continue with request as normal, i.e. the traffic manager will send 504 to the client device 110 the unmodified response. When the traffic manager identifies a request that includes an identity corresponding to details held by the session termination database (503 “Yes”), the traffic manager will send (505) to the client device 110 originating the request, a response containing an indication (for example a command or error code) to cause client device 110 to stop playing content relating to the identity corresponding to the details held by the session termination database. The indication to client device 110 to stop playing content may cause a specific piece of content to be terminated; may cause all content being played on the requesting device to be terminated or may cause content being played on any client device associated with a customer or a household to be terminated. On receiving the response and the indication to stop playing content, one or more client device act to stop playback of relevant content. The one or more client device will stop issuing requests for content covered by the indication and will stop playing the content that has already been fetched and that is covered by the indication.

Once an indication has been sent to a client device to stop playing content relating to a specific session, the traffic manager may remove the information relating to that session from the session termination database. The information might be removed after the command or error code has been sent a set number of times or after a set time period. The client device is then be able to start receiving content to playback including, following a new request, content previously blocked. However, according to a further embodiment of the invention, information relating to a terminated session is maintained in the session termination database. Any new request for content may be checked against the session termination database to see whether or not the requesting client device is allowed to play the requested content. For example, the session termination database may have a record that the client device has been blocked from playing specific content or, alternatively, the device has been blocked from playing any content. In this way, a new request for content may be blocked.

FIG. 6 shows a computer system 60 in accordance with the disclosed aspects. Computer system 60 may correspond to an apparatus that includes a processor 610, memory 612, storage 614, user interface 616 and communications interface 618 and/or other components found in electronic computing devices. Computer system 60 may also include input/output devices (not shown) such as a keyboard, a pointing device and a display communicating with processor 610 via user interface module 616. Computer system 60 may also, via communications interface module 618 (which may comprise a plurality of network interfaces), be connected to or have the capability for connection to one or more communications network, such as a wired, wireless or hybrid LAN, WAN or internet.

1. A method of terminating, at a target client device, playback of content provided from a server to the target client device, in which the method comprises:
identifying a target client device at which playback is to be terminated;
receiving at a service provider network from a requesting client device, a request; in which the request comprises an identifier related to the requesting client device;
reading from the request, the identifier related to the requesting client device and checking a store for an identifier related to the target client device that matches the identifier related to the requesting client device; and
where the store comprises at least one identifier related to the target client device that matches the identifier related to the requesting client device; including in a message sent to the requesting client device in a response to the request, an indication that playback of content should terminate on the requesting client device.

2. The method as claimed in claim 1, in which the request is directed from the requesting client device to a server in the service provider network; in which the request is routed via an intermediate node located between the requesting client device and the server; in which the method comprises:
at the intermediate node:
reading in the request the identifier related to the requesting client device;
checking the store for an identifier related to the target client device that matches the identifier related to the requesting client device; and
where an identifier related to the target client device that matches the identifier related to the requesting client device is identified in the store,
at the intermediate node:
generating the message sent to the requesting client device in a response to the request.

3. The method as claimed in claim 1, in which the request is directed from the requesting client device to a server in the service provider network; in which the request is routed via an intermediate node located between the requesting client device and the server; in which the method comprises:
at the intermediate node:
reading in the request the identifier related to the requesting client device;
checking the store for an identifier related to the target client device that matches the identifier related to the requesting client device; and
where an identifier related to the target client device that matches the identifier related to the requesting client device is identified in the store,
at the intermediate node:
modifying the request by insertion of data for inclusion in the message sent to the requesting client device in a response to the request;
in which the data comprises an indication that playback of content should terminate on the requesting client device.

4. The method as claimed in claim 1, in which the request is directed from the requesting client device to a server in the service provider network; in which the request is routed via an intermediate node located between the requesting client device and the server; in which the method comprises:
at the intermediate node:
reading in the request the identifier related to the requesting client device;
checking the store for an identifier related to the target client device that matches the identifier related to the requesting client device; and
where an identifier related to the target client device that matches the identifier related to the requesting client device is identified in the store;
at the intermediate node:
receiving from the server, a message directed to the requesting client device in a response to the request;
modifying the message directed to the requesting client device by inserting an indication that playback of content should terminate on the requesting client device; and
sending the modified message to the requesting client device.

5. The method as claimed in claim 1, in which each identifier comprises one of a client device identifier, a session identifier, a customer identifier and a household identifier.

6. The method as claimed in claim 1, in which each identifier comprises one of a client device identifier, a session identifier for a session between a server and a client device, a customer identifier for a registered user of a client device and a household identifier registered for at least one client device.

7. A server comprising a processor configured to:
receive from a requesting client device, a request directed to a service provider network;
read from the request an identifier related to the requesting client device;
check a store for an identifier related to a target client device that matches the identifier related to the requesting client device; and
where the store comprises at least one identifier related to a target client device that matches the identifier related to the requesting client device; include in a message sent to the requesting client device in a response to the request, an indication that playback of content should terminate on the requesting client device.

8. The server as claimed in claim 7, further comprising a store accessible to a service provider network, storing at least one identifier related to the target client device.

9. A service provider network comprising the server of claim 7.

10. A computer program element comprising computer program code to, when loaded into a computer system and executed thereon, cause the computer to perform the steps of a method as claimed in claim 1.
